(19) United States
(12) Patent Application Publication
(10) Pub. No.: US 2025/0085967 A1
(43) Pub. Date: Mar. 13, 2025

(54) UPDATING A DOCUMENTATION SET BASED ON A CODE CHANGE IMPACT

(71) Applicant: Capital One Services, LLC, McLean, VA (US)

(72) Inventor: Aidel Miriam WEISBERG, Baltimore, MD (US)

(21) Appl. No.: 18/465,267

(22) Filed: Sep. 12, 2023

(51) Int. Cl. G06F 8/73

(52) U.S. Cl. CPC G06F 8/73

(57) ABSTRACT

In some implementations, a system may receive information associated with the change to the codebase. The system may retrieve the documentation set, the documentation set being associated with the codebase. The system may determine, based on the documentation set and the information associated with the change the codebase, whether the documentation set is to be updated based on the change to the codebase. The system may selectively perform an action associated with updating the documentation set based on the change to the codebase, wherein the action is selectively performed based on a result of determining whether the documentation set is to be updated based on the change to the codebase.

### BACKGROUND

A code repository, also referred to as a version control system (VCS), may be associated with a software tool that manages changes to code over time. A code repository may be used in product development to keep track of changes made to a codebase, to collaborate between developers, and/or to ensure that different versions of the code are properly maintained, among other examples. A code repository may be a centralized code repository (e.g., where all code is stored on a central server, and developers must connect to the server to access the code) or a distributed code repository (e.g., where each developer has their own copy of the code, and changes can be synchronized between copies). A system associated with a code repository may provide features, such as version control, branching, merging, and/or issue tracking, which make it easier for developers to collaborate and maintain high-quality codebases.

### SUMMARY

Some implementations described herein relate to a system for updating a documentation set based on a code change. The system may include one or more memories and one or more processors communicatively coupled to the one or more memories. The one or more processors may be configured to receive information associated with the code change, the code change being a change to a codebase associated with a code repository. The one or more processors may be configured to retrieve the documentation set, the documentation set being associated with the codebase. The one or more processors may be configured to determine, based on the information associated with the code change and the documentation set, that the code change impacts a portion of the documentation set. The one or more processors may be configured to perform, based on the determination that the code change impacts the portion of the documentation set, an action associated with updating the portion of the documentation set based on the code change.

Some implementations described herein relate to a method of updating a documentation set based on a change to a codebase. The method may include receiving, by a system, information associated with the change to the codebase. The method may include retrieving, by the system, the documentation set, the documentation set being associated with the codebase. The method may include determining, by the system and based on the documentation set and the information associated with the change the codebase, whether the documentation set is to be updated based on the change to the codebase. The method may include selectively performing, by the system, an action associated with updating the documentation set based on the change to the codebase, wherein the action is selectively performed based on a result of determining whether the documentation set is to be updated based on the change to the codebase.

Some implementations described herein relate to a non-transitory computer-readable medium that stores a set of instructions. The set of instructions, when executed by one or more processors of a system, may cause the system to receive information associated with a code change, the code change being a change to a codebase associated with a code repository. The set of instructions, when executed by one or more processors of the system, may cause the system to determine, based on the information associated with the code change and a documentation set associated with the codebase, that the code change impacts the documentation set such that a portion of the documentation set should be updated based on the code change. The set of instructions, when executed by one or more processors of the system, may cause the system to provide a message including the information associated with the code change and information indicating the portion of the documentation set.

### BRIEF DESCRIPTION OF THE DRAWINGS

FIGS. 1A and 1B are diagrams of an example associated with updating a documentation set based on a code change impact, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with updating a documentation set based on a code change impact, in accordance with some embodiments of the present disclosure.

FIG. 4 is a flowchart of an example process associated with updating a documentation set based on a code change impact, in accordance with some embodiments of the present disclosure.

### DETAILED DESCRIPTION

The following detailed description of example implementations refers to the accompanying drawings. The same reference numbers in different drawings may identify the same or similar elements.

A code repository may be associated with a software tool that manages changes to code over time. A code repository may be used in product development to keep track of changes made to a codebase, to collaborate between developers, and/or to ensure that different versions of the code are properly maintained, among other examples. A code repository may include, for example, a codebase and one or more other items of information, such as one or more files, one or more libraries, source code, one or more text files (e.g., a text file that contains information about the project, such as a “readme” file), one or more license files (e.g., a text file that specifies licensing terms for the product), one or more configuration files (e.g., files that configure the product to execute in different environments, such as development environments, testing environments, and/or production environments, among other examples), one or more test files (e.g., files that contain automated tests for the product), or one or more build files (e.g., files that are used to build the product from source code, such as scripts and/or configuration files that specify how the product should be compiled and packaged), among other examples.

Additionally, the code repository may include a documentation set associated with the codebase. The documentation set may include, for example, one or more supporting documents, such as end user documentation that is associated with understanding and/or using the product (e.g., a user guide, application programming interface (API) documentation, a technical specification, or the like). An entity may use a code repository system to manage or maintain code repositories for respective functions or applications. For example, developers or teams associated with the entity may create or develop a codebase for one or more functions or applications, and may store information associated with the codebase, such as a documentation set, in a code repository managed by the code repository system.

In practice, a developer may update, revise, edit, or otherwise change the codebase in association with development of a function or application. However, other information associated with the codebase may need to be updated as a result of such a code change. For example, a change to codebase related to a login user interface (UI) may necessitate a change to a list of login instructions provided in a documentation set. Conventionally, determining whether an update to a documentation set is needed, and any update to the documentation set itself, is performed manually. However, updating a documentation set after a code change is often a low priority task, meaning that a given documentation set is often not updated after a code change and, therefore, is out of date when used by, for example, an end user using a product that uses code associated with the codebase. As a result, the product may perform or be executed inefficiently, or may not be usable at all, due to outdated documentation. This reduces efficiency with respect to operation of the product that uses the codebase and, furthermore, can waste resources of a device (e.g., processing resources, power resources, network resources, or the like) with respect to use of the product. Additionally, an outdated documentation set will lead to increased ticket volume for a support system associated with the product, therefore increasing resource consumption of the support system and decreasing availability of the support system to address other issues.

Some implementations described herein enable updating a documentation set based on a code change impact. For example, a system may receive information associated with a code change to a codebase associated with a code repository, and may retrieve a documentation set associated with the codebase. The system may determine, based on the information associated with the code change and the documentation set, that the code change impacts a portion of the documentation set. The system may then perform, based on the determination that the code change impacts the portion of the documentation set, an action associated with updating the portion of the documentation set based on the code change. The action may include, for example, providing a message including information associated with the code change and information associated with the portion of the documentation set that is impacted by the code change. As another example, the action may include generating and providing a suggested documentation set update based on the code change. As another example, the action may include generating and providing an updated portion of the documentation set based on the code change (e.g., such that the documentation set is updated automatically).

In this way, a determination of whether a documentation set needs to be updated after a code change can be performed automatically (e.g., without user intervention) and, if needed, an action associated with updating the documentation set can be automatically initiated. As a result, maintaining an up-to-date documentation can be facilitated, thereby improving performance or execution of a product that uses the codebase, which improves efficiency with respect to operation of the product and, furthermore, reduces resource wastage (e.g., processing resources, power resources, network resources, or the like) with respect to use of the product. Further, by enabling improved updating of a documentation set in response to a code change, ticket volume for a support system associated with the product is decreased, thereby reducing resource consumption of the support system and increasing availability of the support system. Additional details are provided below.

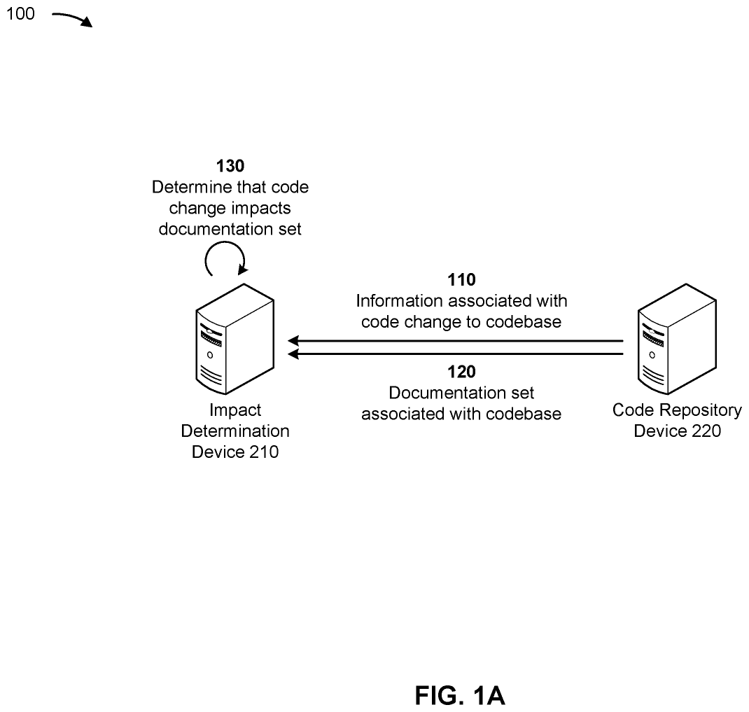

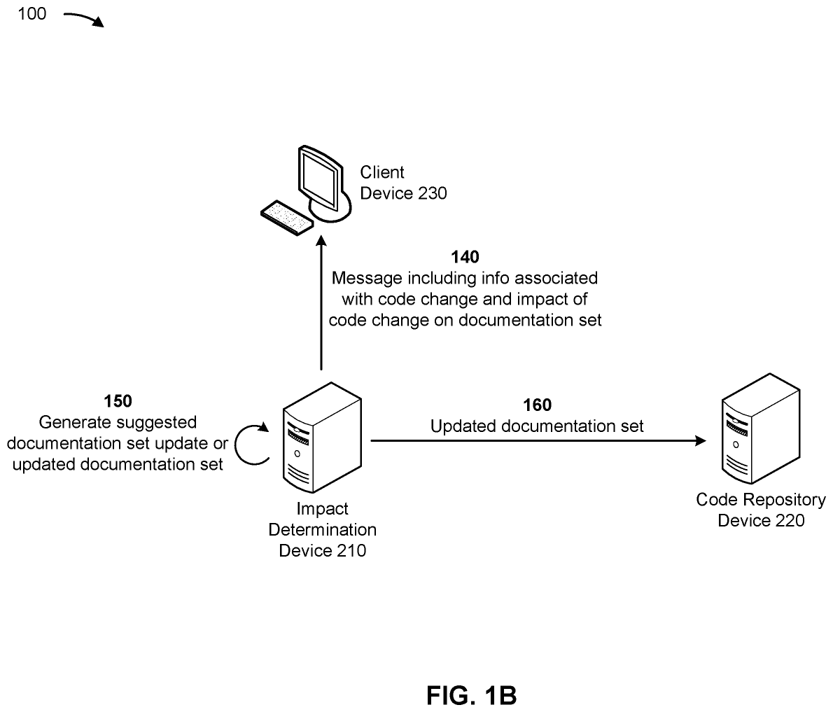

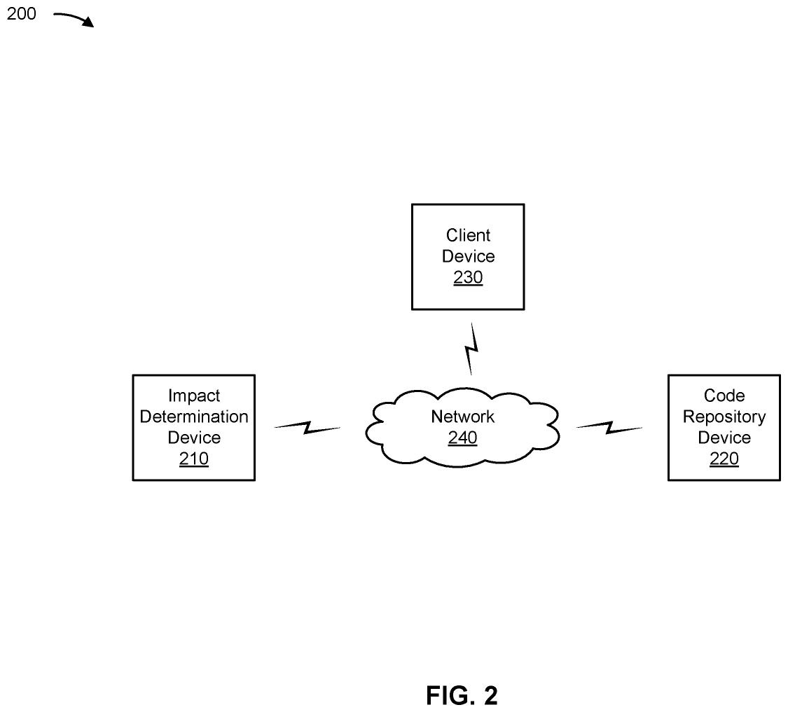

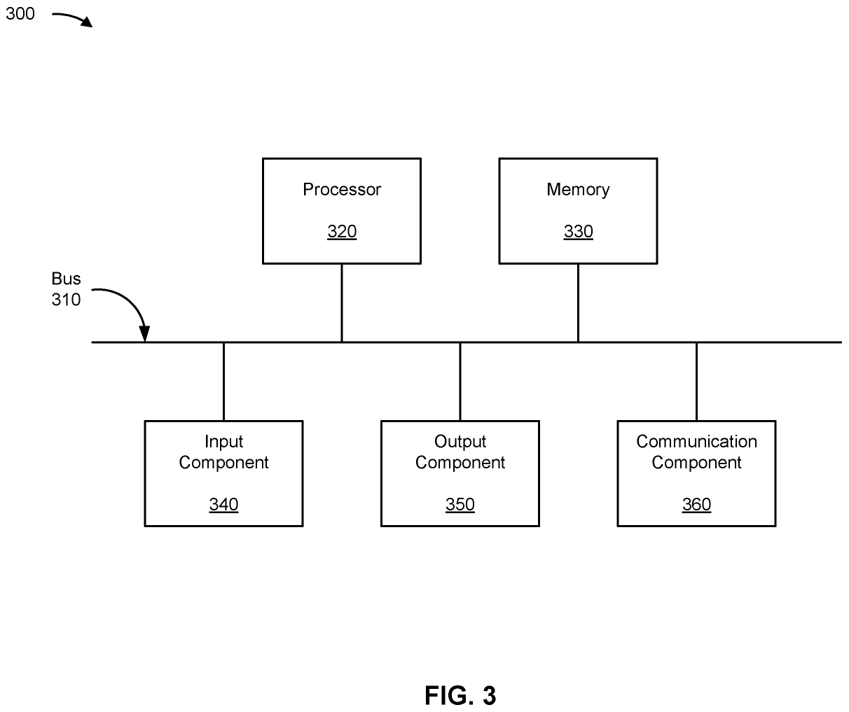

FIGS. 1A and 1B are diagrams of an example 100 associated with updating a documentation set based on a code change impact. As shown in FIGS. 1A and 1B, example 100 includes an impact determination device 210, a code repository device 220, and a client device 230. These devices are described in more detail in connection with FIGS. 2 and 3.

As shown in FIG. 1A at reference 110, the impact determination device 210 may receive information associated with a code change. For example, the impact determination device 210 may receive information associated with a change to a codebase associated with a code repository (e.g., a code repository stored or managed by the code repository device 220). The information associated with the code change may include, for example, one or more lines of updated code, one or more lines of previous code (e.g., one or more lines of code prior to being updated), a pointer indicating a location of the code change in the codebase, or another type of information associated with the code change.

In some implementations, the impact determination device 210 may receive the information associated with the code change from the code repository device 220. For example, the code repository device 220 may be configured with a script that causes the code repository device 220 to provide the information associated with the code change to the impact determination device 210 when the code repository device 220 receives an update to the codebase or otherwise determines that a code change has been made. Thus, in some implementations, the impact determination device 210 may automatically (e.g., without user intervention) receive the information associated with the code change. Additionally, or alternatively, the impact determination device 210 may receive the information associated with the code change based on a request (e.g., when the impact determination device 210 is configured to request information associated with any code changes on a periodic basis or in response to user input).

As shown at reference 120, the impact determination device 210 may retrieve a documentation set associated with the codebase. The documentation set may include one or more supporting documents associated with a product that uses the codebase. As a particular example, the documentation set may include end user documentation that is associated with understanding and/or using the product, such as a user guide, API documentation, or a technical specification, among other examples. In some implementations, the documentation set may include a set of markdown files (e.g., a set of markdown files stored on the code repository device 220).

In some implementations, as indicated in FIG. 1A, the impact determination device 210 may retrieve the documentation set from the code repository device 220. For example, the impact determination device 210 may request the documentation set from the code repository device 220, and the code repository device 220 may provide the documentation set to the impact determination device 210 in response to the request. As another example, the code repository device 220 may (automatically) provide the documentation set to the impact determination device 210 when the code repository device 220 provides the information associated with the code change to the impact determination device 210.

Additionally, or alternatively, the impact determination device 210 may retrieve the documentation set from a memory of the impact determination device 210. For example, the impact determination device 210 may be configured with mapping information that maps each codebase in a pool of codebases to a respective documentation set in a pool of documentation sets stored on the impact determination device 210. In such an implementation, the information associated with the code change may include information that indicates the codebase associated with the code change, and the impact determination device 210 may identify the documentation set associated with the codebase based on the information that indicates the codebase.

As shown at reference 130, the impact determination device 210 may determine, based on the information associated with the code change and the documentation set, whether the code change impacts the documentation set. In some implementations, the impact determination device 210 may determine that the code change impacts the documentation set when, for example, the code change is likely to cause a meaning of a portion of the documentation set (e.g., language in the documentation set) to change, or when the code change is likely to change a manner in which a user uses the product (e.g., such that an update to the documentation set would be needed).

In some implementations, the impact determination device 210 determines whether the code change impacts the documentation set using an impact model that is stored by or accessible to the impact determination device 210. In one example, the impact model may be configured to receive the information associated with the code change and the documentation set (e.g., a set of markdown files) as input, and to provide an output that indicates whether the code change impacts the documentation set such that a code change is needed. In some implementations, the information associated with the code change may include original code (e.g., the portion of the code prior to the code change) or updated code (e.g., the portion of the code after the code change). The output may include, for example, an indication associated with whether there is an impact on the documentation set, an indication of one or more portions of the code change (e.g., one or more updated lines of code) that caused an impact on the documentation set, an indication of one or more portions of the documentation set that are impacted, an impact score (e.g., a value indicating a degree to which the code change impacts the documentation set), or another type of information associated with the impact of the code change, the code change, or the documentation set.

In some implementations, the impact model may be a model configured to process data (e.g., the information associated with the code change, the documentation set, or the like) to determine whether the code change impacts the documentation set. In some implementations, the impact model may be configured or trained using one or more artificial intelligence (AI) techniques. The one or more AI techniques may include, for example, machine learning, a convolutional neural network, deep learning, language processing, or the like. For example, in some implementations, the one or more artificial intelligence techniques may enable the impact determination device 210 to compare data relating to a code change (e.g., one or more original lines of code, one or more updated lines of code, or the like) to data relating to a documentation set (e.g., one or more portions of the documentation set that are associated with the one or more lines of changed code and original code). In one example, the impact mode may use one or more AI techniques that enable the impact determination device 210 to interpret one or more portions of the documentation set (e.g., based on the original code), and determine whether an interpretation after the code change is altered such that an update to the documentation set is needed.

In some implementations, the impact model may compute an impact score based at least in part on the information associated with the code change and the documentation set. The impact score may be a value indicating a degree to which the code change impacts the documentation set. In one example, if the impact score satisfies (e.g., is greater than or equal to) an impact threshold, then the impact determination device 210 may determine that the code change impacts the documentation set. Alternatively, if the impact score fails to satisfy (e.g., is less than) the impact threshold, then the impact determination device 210 may determine that the code change does not impact the documentation set.

In some implementations, if the impact determination device 210 determines that the code change does not impact the documentation set, then the impact determination device 210 may refrain from taking an action associated with updating the documentation set. That is, if the impact determination device 210 determines that the code change does not impact the documentation set sufficiently to necessitate an update to the documentation set, then the impact determination device 210 may take no action with respect to updating the documentation set. In some implementations, the impact determination device 210 may provide (e.g., to the client device 230) a message indicating that the impact determination device 210 determined that no update to the documentation set based on the code change is needed. In some implementations, the message may include information associated with the code change or one or more items of information associated with the determination that no update to the documentation set is needed.

Alternatively, as shown by reference 130, the impact determination device 210 may determine that the code change impacts the documentation set. In such a scenario, the impact determination device 210 may perform an action associated with updating a portion of the documentation set that is impacted by the code change.

In one example, as shown in FIG. 1B at reference 140, the impact determination device 210 provides (e.g., to client device 230) a message including information associated with the code change and information associated with the portion of the documentation set that is impacted by the code change. For example, the impact determination device 210 may provide a message (e.g., an email) to notify a user of the client device 230 that a code change was made to a particular item of code in the codebase and that the code change may impact the associated documentation set at a particular location. The user can then confirm whether an update to the documentation set is needed and proceed accordingly.

In another example of an action performed by the impact determination device 210, as shown at reference 150, the impact determination device 210 may in some implementations generate and provide a suggested documentation set update based on the code change. For example, the impact determination device 210 may be configured with or have access to a large language model (LLM) configured to receive information associated with the code change and information associated with the impacted portion of the documentation set as input, and provide a suggested documentation set update as an output. In this example, the impact determination device 210 may provide (e.g., to the client device 230 and/or to the code repository device 220) a message including information associated with the suggested documentation set update and information associated with the code change. The user can then confirm whether to edit and/or incorporate the suggested documentation set update accordingly. As one example, the suggested documentation set update generated by the impact determination device 210 may comprise a pull request (PR) that includes a suggested documentation set update generated by the impact determination device 210 (e.g., using an LLM). In one example, the impact determination device 210 may provide the PR to the code repository device 220 and/or to the client device 230 to await acceptance of the model-generated PR and/or editing of the model-generated PR by a user.

In another example of an action performed by the impact determination device 210, as shown at reference 160, the impact determination device 210 may in some implementations generate and provide an updated portion of the documentation set based on the code change. For example, the impact determination device 210 may be configured with or have access to an LLM configured to receive information associated with the code change and information associated with the impacted portion of the documentation set as input, and provide an updated documentation set update as an output. In this example, the impact determination device 210 may provide (e.g., to the code repository device 220) a message including information associated with the updated portion of the documentation set. Here, the code repository device 220 may receive the message and (automatically) update the documentation set, accordingly. As one example, the updated portion of the documentation set generated by the impact determination device 210 may comprise a PR that includes a documentation set update generated by the impact determination device 210 (e.g., using an LLM). In one example, the impact determination device 210 may provide the PR to the code repository device 220 and the PR may be executed by the code repository device 220 so that the portion of the documentation set is updated automatically (e.g., without user intervention) according to the documentation set update generated by the impact determination device 210.

In some implementations, a suggested documentation set update or an updated portion of the documentation set may be generated based on style information associated with the documentation set. For example, the impact determination device 210 may store or have access to style information (e.g., a style guide) associated with the documentation set. In such a scenario, the impact determination device 210 may generate a suggested documentation set update or an updated portion of the documentation set according to the style information (e.g., such that the suggested documentation set update or the updated portion of the documentation set conforms to the style guide associated with the documentation set).

In some aspects, the impact determination device 210 may adjust a model used to generate the suggested documentation set update or the updated portion of the documentation set based on feedback information. For example, a user of the client device 230 may edit the suggested documentation set update or the updated portion of the documentation set (e.g., after the impact determination device 210 generates the suggested documentation set update or the updated portion of the documentation set). Here, the client device 230 may provide information associated with the edit to the impact determination device 210, and the impact determination device 210 may adjust the model (e.g., the LLM) used to generate the suggested documentation set update or the updated portion of the documentation set based on the edit (e.g., such that a future suggestion or update takes into account the edit). In some implementations, the feedback information may be associated with a PR generated by the impact determination device 210. For example, the impact determination device 210 may generate a PR including a suggested documentation set update, as described above. Here, the user of the client device 230 may edit the PR including the suggested documentation set update (e.g., before incorporating the suggested documentation set update), and the impact determination device 210 may receive, from the client device 230, information associated with the edited PR (e.g., information indicating changes made to the PR by the user). Here, the information associated with the edited PR may serve as feedback information, and the impact determination device 210 may adjust the model used to generated the suggested documentation set update based on the information associated with the edited PR.

In this way, a determination of whether a documentation set needs to be updated after a code change can be performed automatically (e.g., without user intervention) and, if needed, an action associated with updating the documentation set can be automatically initiated. As a result, maintaining an up-to-date documentation set can be facilitated, thereby improving performance or execution of a product that uses the codebase, which improves efficiency with respect to operation of the product and, furthermore, reduces resource wastage (e.g., processing resources, power resources, network resources, or the like) with respect to use of the product. Further, by enabling improved updating of a documentation set in response to a code change, ticket volume for a support system associated with the product is decreased, thereby reducing resource consumption of the support system and increasing availability of the support system.

Additionally, in some implementations, the impact determination device 210 may perform an action associated with updating the documentation set based on a proposed change to the documentation set and based on a ruleset associated with the documentation set. For example, the impact determination device 210 may in some implementations receive information associated with a proposed change to the documentation set, and may perform, based on a ruleset associated with the documentation set, an action associated with updating the documentation set based on the proposed change to the documentation set. Thus, in some implementations, the impact determination device 210 may be capable of receiving information associated with a proposed change to the documentation set, and can verify the proposed change quality, style conformance, or the like. In such an implementation, a trigger to cause the impact determination device 210 to perform the action is a change to the documentation set itself (rather than a code change).

As indicated above, FIGS. 1A and 1B are provided as an example. Other examples may differ from what is described with regard to FIGS. 1A and 1B.

FIG. 2 is a diagram of an example environment 200 in which systems and/or methods described herein may be implemented. As shown in FIG. 2, environment 200 may include an impact determination device 210, a code repository device 220, a client device 230, and a network 240. Devices of environment 200 may interconnect via wired connections, wireless connections, or a combination of wired and wireless connections.

The impact determination device 210 may include one or more devices capable of receiving, generating, storing, processing, providing, and/or routing information associated with updating a documentation set based on a code change impact, as described elsewhere herein. The impact determination device 210 may include a communication device and/or a computing device. For example, the impact determination device 210 may include a server, such as an application server, a client server, a web server, a database server, a host server, a proxy server, a virtual server (e.g., executing on computing hardware), or a server in a cloud computing system. In some implementations, the impact determination device 210 may include computing hardware used in a cloud computing environment.

The code repository device 220 may include one or more devices capable of receiving, generating, storing, processing, providing, and/or routing information associated with updating a documentation set based on a code change impact, as described elsewhere herein. The code repository device 220 may include a communication device and/or a computing device. For example, the code repository device 220 may include a server, such as an application server, a client server, a web server, a database server, a host server, a proxy server, a virtual server (e.g., executing on computing hardware), or a server in a cloud computing system. In some implementations, the code repository device 220 may include computing hardware used in a cloud computing environment. The code repository device 220 may be associated with a provider of a product development service and/or a version control service.

The client device 230 may include one or more devices capable of receiving, generating, storing, processing, and/or providing information associated with updating a documentation set based on a code change impact, as described elsewhere herein. The client device 230 may include a communication device and/or a computing device. For example, the client device 230 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The network 240 may include one or more wired and/or wireless networks. For example, the network 240 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 240 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with updating a documentation set based on a code change impact. The device 300 may correspond to impact determination device 210, code repository device 220, and/or client device 230. In some implementations, impact determination device 210, code repository device 220, and/or client device 230 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

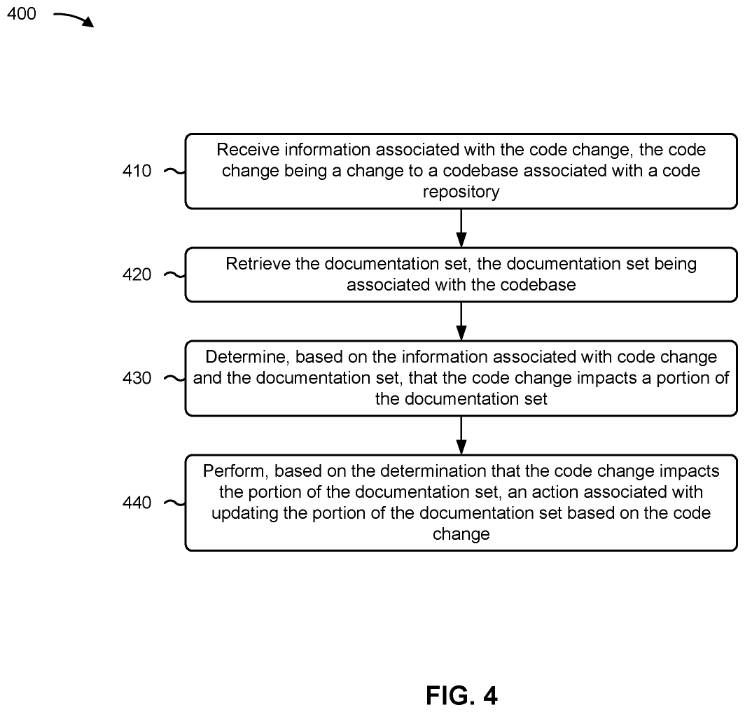

FIG. 4 is a flowchart of an example process 400 associated with updating a documentation set based on a code change impact. In some implementations, one or more process blocks of FIG. 4 may be performed by the impact determination device 210. In some implementations, one or more process blocks of FIG. 4 may be performed by another device or a group of devices separate from or including the impact determination device 210, such as the code repository device 230 and/or the client device 230. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving information associated with a code change, the code change being a change to a codebase associated with a code repository (block 410). For example, the impact determination device 210 (e.g., using processor 320, memory 330, input component 340, and/or communication component 360) may receive information associated with a code change, the code change being a change to a codebase associated with a code repository, as described above in connection with reference number 110 of FIG. 1A. As an example, the impact determination device 210 may receive information associated with a change to a codebase related to a login of a UI.

As further shown in FIG. 4, process 400 may include retrieving a documentation set, the documentation set being associated with the codebase (block 420). For example, the impact determination device 210 (e.g., using processor 320 and/or memory 330) may retrieve a documentation set, the documentation set being associated with the codebase, as described above in connection with reference number 120 of FIG. 1A. As an example, the impact determination device 210 may retrieve a documentation set (e.g., a set of markdown files) that includes a list of login instructions associated with the UI.

As further shown in FIG. 4, process 400 may include determining, based on the information associated with the code change and the documentation set, that the code change impacts a portion of the documentation set (block 430). For example, the impact determination device 210 (e.g., using processor 320 and/or memory 330) may determine, based on the information associated with the code change and the documentation set, that the code change impacts a portion of the documentation set, as described above in connection with reference number 130 of FIG. 1A. As an example, the impact determination device 210 may determine that the change to the codebase related to the login of the UI impacts the list of login instructions, associated with the UI, that is included in the documentation set.

As further shown in FIG. 4, process 400 may include performing, based on the determination that the code change impacts the portion of the documentation set, an action associated with updating the portion of the documentation set based on the code change (block 440). For example, the impact determination device 210 (e.g., using processor 320 and/or memory 330) may perform, based on the determination that the code change impacts the portion of the documentation set, an action associated with updating the portion of the documentation set based on the code change, as described above in connection with reference numbers 140, 150, and 160 of FIG. 1B. As an example, the impact determination device 210 may provide a message including information associated with the change to the codebase related to the login of the UI and an indication that the list of login instructions in the documentation set is impacted by the change to the codebase. As another example, the impact determination device 210 may generate (and provide) a suggested update to the list of login instructions based on the change to the codebase related to the login of the UI. As another example, the impact determination device 210 may generate (and provide) an updated list of instructions based on the change to the codebase related to the login of the UI.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A and 1B. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for updating a documentation set based on a code change, the system comprising:
one or more memories; and
one or more processors, communicatively coupled to the one or more memories, configured to:
receive information associated with the code change, the code change being a change to a codebase associated with a code repository;
retrieve the documentation set, the documentation set being associated with the codebase;
determine, based on the information associated with the code change and the documentation set, that the code change impacts a portion of the documentation set; and
perform, based on the determination that the code change impacts the portion of the documentation set, an action associated with updating the portion of the documentation set based on the code change.

2. The system of claim 1, wherein the one or more processors, to perform the action associated with the updating the documentation set, are configured to provide a message including information associated with the code change and information associated with the portion of the documentation set that is impacted by the code change.

3. The system of claim 1, wherein the one or more processors, to perform the action associated with the updating the documentation set, are configured to:
generate a suggested documentation set update based on the code change, and
provide a message including information associated with the suggested documentation set update.

4. The system of claim 3, wherein the one or more processors are further configured to adjust a model used to generate the suggested documentation set update based on feedback information associated with the suggested documentation set update.

5. The system of claim 1, wherein the one or more processors, to perform the action associated with the updating the documentation set, are configured to:
generate an updated portion of the documentation set based on the code change, and
provide a message including information associated with the updated portion of the documentation set.

6. The system of claim 1, wherein the documentation set comprises a set of markdown files.

7. The system of claim 1, wherein the documentation set is an end user documentation set.

8. The system of claim 1, wherein the action associated with updating the documentation set is performed based on style information associated with the documentation set.

9. The system of claim 1, wherein the one or more processors are further configured to:
receive information associated with a proposed change to the documentation set; and
perform, based on a ruleset associated with the documentation set, an action associated with updating the documentation set based on the proposed change to the documentation set.

10. A method of updating a documentation set based on a change to a codebase, comprising:
receiving, by a system, information associated with the change to the codebase;
retrieving, by the system, the documentation set, the documentation set being associated with the codebase;
determining, by the system and based on the documentation set and the information associated with the change the codebase, whether the documentation set is to be updated based on the change to the codebase; and
selectively performing, by the system, an action associated with updating the documentation set based on the change to the codebase,
wherein the action is selectively performed based on a result of determining whether the documentation set is to be updated based on the change to the codebase.

11. The method of claim 10, wherein the result indicates that the documentation set is to be updated, and selectively performing the action associated with the updating the documentation set comprises providing a message indicating the result of determining whether the documentation set is to be updated based on the change to the codebase.

12. The method of claim 10, wherein the result indicates that the documentation set is to be updated, and selectively performing the action associated with the updating the documentation set comprises:
generating a suggested documentation set update based on the change to the codebase, and
providing information associated with the suggested documentation set update.

13. The method of claim 12, further comprising adjusting a model used to generate the suggested documentation set update based on feedback information associated with the suggested documentation set update.

14. The method of claim 10, wherein the result indicates that the documentation set is to be updated, and selectively performing the action associated with the updating the documentation set comprises:
generating an updated documentation set based on the change to the codebase, and
providing information associated with the updated documentation set.

15. The method of claim 10, wherein the result indicates that the documentation set is not to be updated, and selectively performing the action associated with the updating the documentation set comprises refraining from updating the documentation set.

16. The method of claim 10, wherein the documentation set comprises a set of markdown files.

17. The method of claim 10, wherein the documentation set is an end user documentation set.

18. A non-transitory computer-readable medium storing a set of instructions, the set of instructions comprising:
one or more instructions that, when executed by one or more processors of a system, cause the system to:
receive information associated with a code change, the code change being a change to a codebase associated with a code repository;
determine, based on the information associated with the code change and a documentation set associated with the codebase, that the code change impacts the documentation set such that a portion of the documentation set should be updated based on the code change; and
provide a message including the information associated with the code change and information indicating the portion of the documentation set.

19. The non-transitory computer-readable medium of claim 18, wherein the one or more instructions further cause the system to:
generate a suggested documentation set update based on the code change, and
provide information associated with the suggested documentation set update.

20. The non-transitory computer-readable medium of claim 18, wherein the one or more instructions further cause the system to update the portion of the documentation set based on the code change.
